(19) United States
(12) Patent Application Publication
(10) Pub. No.: US 2008/0120568 A1
(43) Pub. Date: May 22, 2008

(54) METHOD AND DEVICE FOR ENTERING DATA USING A THREE DIMENSIONAL POSITION OF A POINTER

(75) Inventors: SUN JIAN, SINGAPORE (SG); LIM SWEE HO, SINGAPORE (SG); TAN CHOON LEONG, SINGAPORE (SG)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/561,648

(22) Filed: Nov. 20, 2006

(51) Int. Cl. G06F 3/048

(52) U.S. Cl. 715/781

(57) ABSTRACT

A method and device for entering data enables intuitive and efficient displays of graphical user interfaces using three dimensional movements of a pointer (205). The method includes associating a first graphical user interface of an electronic device (100) with a first space (210) defined between a control surface such as a display screen (105) and a first plane (215) substantially parallel to the control surface. A second graphical user interface is associated with a second space (220) defined between the first plane (215) and a second plane (225) substantially parallel to the control surface. The second graphical user interface is then displayed on the display screen (105) of the electronic device (100) in response to detecting a location of the pointer (205) within the second space (220). Data are then entered into the electronic device (100) in response to a user interaction with the second graphical user interface.

### FIELD OF THE INVENTION

The present invention relates generally to electronic devices, and in particular to entering data into electronic devices that display graphical user interfaces on a display screen.

### BACKGROUND

Conventional methods for entering data into handheld electronic devices include the use of buttons and touch screens. A button is essentially a one dimensional data input apparatus, where depressing a button triggers a particular event. A touch screen or touch pad is generally a two dimensional data input apparatus, where data can be identified, selected or entered using x and y coordinates. Further, it is also known to use three dimensional data input apparatus to enter data into computers.

Three dimensional data input apparatus include, for example, the use of three dimensional (3D) stereo imaging techniques involving multiple cameras, and other 3D sensing techniques involving capacitance sensing of a stylus or the use of gyroscopic or acceleration sensors included in a stylus or other type of movement sensor. However, graphical user interfaces (GUIs) adapted to function with such 3D data input apparatus are often complex and difficult to operate.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating a multi-function wireless communication device in the form of a mobile telephone, according to some embodiments of the present invention.

FIG. 2 is a diagram illustrating a side view of a mobile telephone including a vertical position of a stylus above a display screen, according to some embodiments of the present invention.

FIG. 3 is a diagram illustrating various regions of a display screen of a mobile telephone, according to some embodiments of the present invention.

FIG. 4 is a diagram illustrating use of a stylus to display on a display screen three graphical user interfaces associated with a media player of a mobile telephone, according to some embodiments of the present invention.

FIG. 5 is a general flow diagram illustrating a method for entering data into an electronic device, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to entering data into an electronic device. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, horizontal and vertical, up and down, above and below, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method or device that comprises a list of elements does not include only those elements but may include other elements not expressly listed or inherent to such process, method, or device. An element preceded by “comprises a . . . ” does not, without more constraints, preclude the existence of additional identical elements in the process, method or device that comprises the element.

According to one aspect of the invention there is provided a method for entering data into an electronic device, the method comprising associating a first graphical user interface with a first space defined between a control surface and a first plane substantially parallel to the control surface. The method also performs associating a second graphical user interface with a second space defined between the first plane and a second plane substantially parallel to the control surface. There method also effects displaying the second graphical user interface on a display screen of the electronic device in response to detecting a location of a pointer within the second space and thereafter there is performed entering data into the electronic device in response to a user interaction with the second graphical user interface.

According to another aspect of the invention there is provided electronic device comprising a computer readable program code components configured to cause associating a first graphical user interface with a first space defined between a control surface and a first plane substantially parallel to the control surface. The device also has computer readable program code components configured to cause associating a second graphical user interface with a second space defined between the first plane and a second plane substantially parallel to the control surface. Further, the device has computer readable program code components configured to cause displaying the second graphical user interface on a display screen of the electronic device in response to detecting a location of a pointer within the second space. The device further includes computer readable program code components configured to cause entering data into the electronic device in response to a user interaction with the second graphical user interface.

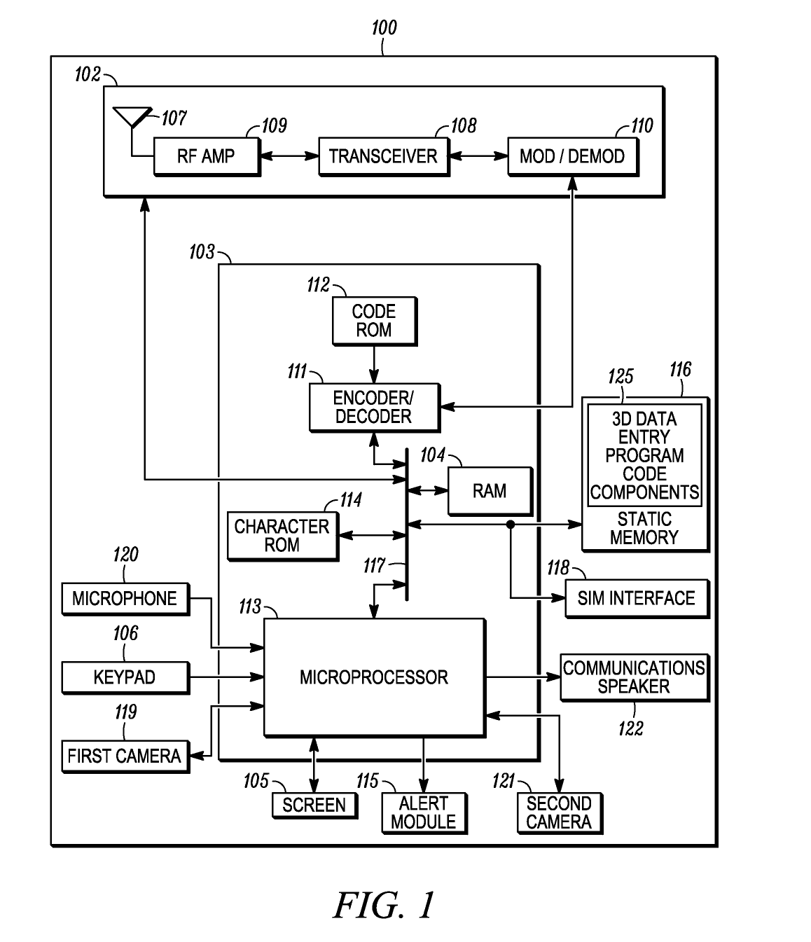

Referring to FIG. 1, a schematic diagram illustrates a multi-function wireless communication device in the form of a mobile telephone 100, according to some embodiments of the present invention. The telephone 100 comprises a radio frequency communications unit 102 coupled to be in communication with a common data and address bus 117 of a processor 103. The telephone 100 also has a keypad 106 and a display screen 105, such as a touch screen, coupled to be in communication with the processor 103.

The processor 103 also includes an encoder/decoder 111 with an associated code Read Only Memory (ROM) 112 for storing data for encoding and decoding voice or other signals that may be transmitted or received by the mobile telephone 100. The processor 103 further includes a microprocessor 113 coupled, by the common data and address bus 117, to the encoder/decoder 111, a character Read Only Memory (ROM) 114, a Random Access Memory (RAM) 104, programmable memory 116 and a Subscriber Identity Module (SIM) interface 118. The programmable memory 116 and a SIM operatively coupled to the SIM interface 118 each can store, among other things, selected text messages and a Telephone Number Database (TND) comprising a number field for telephone numbers and a name field for identifiers associated with one of the numbers in the name field.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that is coupled to the encoder/decoder 111.

The microprocessor 113 has ports for coupling to the keypad 106 and to the display screen 105. The microprocessor 113 further has ports for coupling to an alert module 115 that typically contains an alert speaker, vibrator motor and associated drivers, to a microphone 120, to a first camera 119, to a second camera 121, and to a communications speaker 122. The character ROM 114 stores code for decoding or encoding data such as text messages that may be received by the communications unit 102. In some embodiments of the present invention, the character ROM 114, the programmable memory 116, or a SIM also can store operating code (OC) for the microprocessor 113 and code for performing functions associated with the mobile telephone 100. For example, the programmable memory 116 can comprise three dimensional (3D) data entry computer readable program code components 125 configured to cause execution of a method for entering data, according to some embodiments of the present invention.

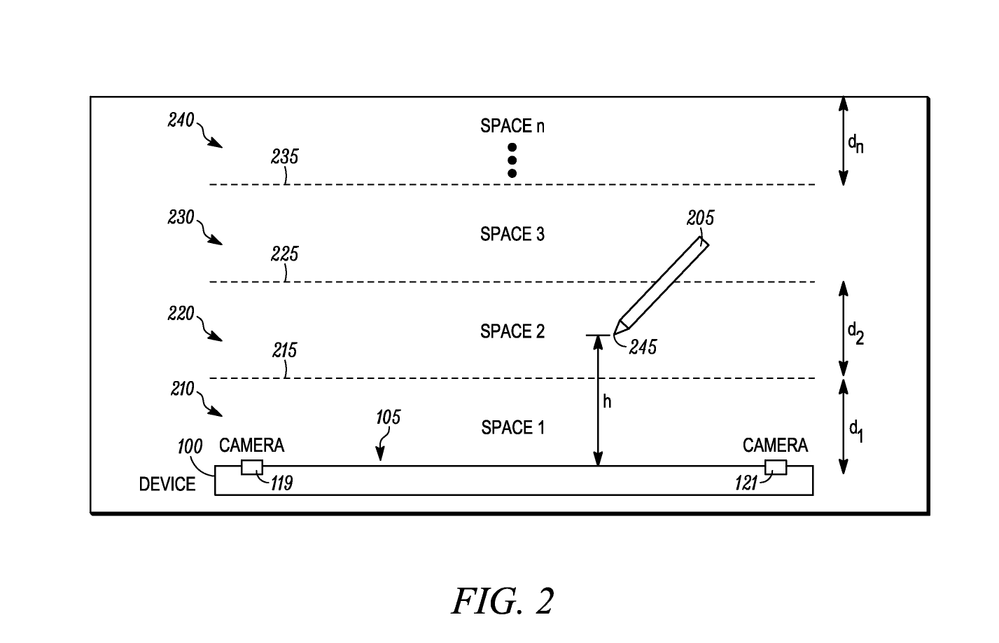

Referring to FIG. 2, a diagram illustrates a side view of the mobile telephone 100 including the vertical position of a stylus 205 above the display screen 105, according to some embodiments of the present invention. The first camera 119 and the second camera 121 are shown at different ends of the mobile telephone 100, enabling three dimensional (3D) stereo imaging of the stylus 205. A volume above the display screen 105 then can be divided into a plurality of layers of three dimensional space. For example, a first space 210 is defined between an outer surface of the display screen 105 and a first plane 215 that is above the display screen 105 and substantially parallel to the display screen 105. A second space 220 is defined between the first plane 215 and a second plane 225. A third space 230 is defined between the second plane 225 and a third plane 235. Additional spaces can be defined in a similar manner up to an n^{th} space 240. Each space 210, 220, 230, 240 has a height d that is normal to the outer surface of the display screen 105.

According to embodiments of the present invention, a different graphical user interface (GUI) can be associated with each space 210, 220, 230, 240 above the display screen 105. For example, a first GUI can be associated with the first space 210, a second GUI can be associated with the second space 220, a third GUI can be associated with the third space 230, and an n^{th} GUI can be associated with the n^{th} space 240.

Such associations can enable intuitive and efficient user interaction with the display screen 105. For example, if a user seeks to interact with a second GUI that is associated with the second space 220, the user can first hold the stylus 205 above the nth space 240 and then move the stylus toward the display screen 105. As a tip 245 of the stylus 205 passes through the nth space 240, the display screen 105 displays the nth GUI that is associated with the nth space 240. Such a display is enabled by processing 3D stereo images of the tip 245, which images are received at the first camera 119 and the second camera 121, and detecting a three dimensional location of the tip 245 within the nth space 240.

Next, as the tip 245 of the stylus 205 passes through the third space 230, the display screen 105 changes to display the third GUI associated with the third space 230. Finally, as the tip 245 of the stylus 205 passes through the second space 220, the display screen 105 changes again to display the second GUI associated with the second space 220. If the tip 245 remains within the second space 220, such as at a height h above the outer surface of the display screen 105, the display screen 105 continues to display the second GUI. A user then can enter data into the mobile telephone 100 by interacting with the second GUI, such as by selecting items from a menu or by selecting a hyperlink.

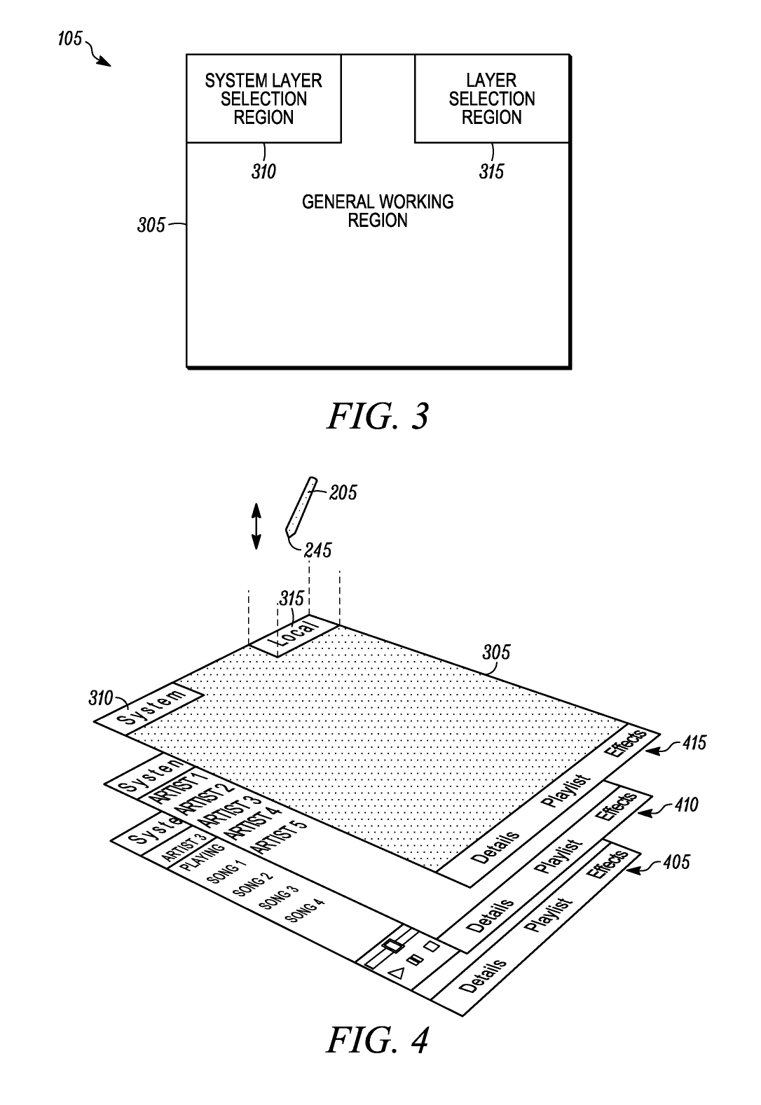

Referring to FIG. 3, a diagram illustrates various regions of the display screen 105 of the mobile telephone 100, according to some embodiments of the present invention. A general working region 305 is used to display various GUIs associated with applications of the mobile telephone 100. A system layer selection region 310 defined as a portion of the display screen 105 is used to select between various GUIs associated with different systems or applications. Such systems or applications can include, for example, an electronic address book, a multimedia player, an Internet browser, an email program, games, an image editor, and various other programs and features. As described above concerning FIG. 2, a user can switch between such systems or applications by moving a pointer, such as the stylus 205, up and down over the system layer selection region 310. Depending on the vertical height of the tip 245 of the stylus 205 above the system layer selection region, the general working region 305 will display a GUI that is associated with a space in which the tip 245 is located.

After a desired GUI concerning a desired application is displayed in the general working region 305, a user can choose to interact with the desired GUI in various ways. For example, according to some embodiments of the present invention, a desired GUI can be selected by moving the tip 245 of the stylus 205 horizontally out of a 3D space directly above the system layer selection region 310. That can cause the display screen 105 to be locked to the GUI that was last selected based on the vertical position of tip 245 when the tip 245 was last directly above the system layer selection region 310. A user then can interact with the selected GUI shown in the general working region 305 in a typical two-dimensional (2D) manner, as is well known in the art. For example, the tip 245 of the stylus 205 can be placed against the outer surface of the display screen 105 within the general working region 305, and interactions with a GUI can be performed by horizontal movement of the tip 245 or by tapping the tip 245 against the display screen 105.

According to other embodiments of the present invention, selection of a particular GUI can be made using the system layer selection region 310 using a predetermined movement of the tip 245 of the stylus 205 within a space, such as the space 210, 220, 230 or 240, directly above the system layer selection region 310. For example, the mobile telephone 100 can be programmed to interpret a rapid up and down movement of the tip 245, or a rapid left and right movement of the tip 245, as a signal to select a particular GUI that is displayed in the general working region 305. The tip 245 of the stylus 205 then can be removed from directly above the system layer selection region 310 without changing the selected GUI.

A local layer selection region 315 operates in a manner similar to the system layer selection region 31 0. However, movement of a pointer, such as the stylus 205, directly above the local layer selection region 315 is used to display and select GUIs associated with a particular system or application. For example, the system layer selection region 310 can be used to display and select a GUI associated with an email application on the mobile telephone 100. The local layer selection region 315 then can be used to display and select various GUIs associated with the email application, such as an email inbox GUI, an email outbox GUI, and an email deleted items GUI.

Referring to FIG. 4, a diagram illustrates use of the stylus 205 to display on the display screen 105 three GUIs associated with a media player of the mobile telephone 100, according to some embodiments of the present invention. A first GUI 405 displays control details of the media player, a second GUI 410 displays a playlist of the media player, and a third GUI 415 displays special effects of the media player. As illustrated, a user can switch from the first GUI 405, to the second GUI 410, and to the third GUI 415 by moving the tip 245 of the stylus 205 upward from the outer surface of the display screen 105, directly above the local layer selection region 315, through a first space, such as the first space 210, through a second space, such as the second space 220, and to a third space, such as the third space 230, respectively.

Embodiments of the present invention therefore enable a user to enter data into an electronic device such as the mobile telephone 100 using intuitive and efficient three dimensional movements of a pointer such as the stylus 205. Many devices include multiple GUIs that can be easily visualized by a user as stacked layers. For example, multiple GUIs associated with multiple pages of an electronic document can be easily visualized as stacked physical pages. Embodiments of the present invention thus enable a user to navigate through such multiple pages using a natural up and down movement of a pointer.

Furthermore, embodiments of the present invention can be used to display a series of images that zoom in on an initial image in response to movement of a pointer toward the display screen 105, and zoom out from an initial image in response to movement of the pointer away from the display screen 105. For example, consider that in FIG. 2 the distances d between the outer surface of the display screen 105 and the plane 215, and between the planes 215, 225, and 235, are reduced to a very small value. Incremental vertical movement of the tip 245 of the stylus 205 up or down above the display screen 105 will then result in a change from one space to another, such as from the space 220 to the space 230. Various GUIs associated with the spaces 210, 220, 230 and 240 then can be defined as different magnifications of a single image. Thus a user can navigate an image by panning and zooming using, respectively, very natural and intuitive horizontal and vertical movements of the stylus 205. Such navigation can occur, for example, above the general working region 305 after an image editor application is selected from the system layer selection region 310.

Those skilled in the art will appreciate that a graphical user interface (GUI) according to the present invention can be any type of interface that includes graphics or text to represent information and actions that are available to a user of an electronic device. For example, such graphics can include pull down menus, hyperlinks, hypertext, control buttons, and text entry fields. Entering data in response to user interaction with such GUIs can comprise various actions such as, for example, selecting an item from a menu, “clicking” on a hyperlink, “clicking” on a control button, or keying text into a text entry field. Further, such interactions can be performed using one of various types of pointers including, for example, a stylus, such as the stylus 205, a pen, a pencil, or even a finger. As described above, a three dimensional position of such a pointer can be detected in various ways known in the art, such as using three dimensional stereo imaging, radio frequency (RF) positioning, or using capacitance, gyroscopic or acceleration sensors.

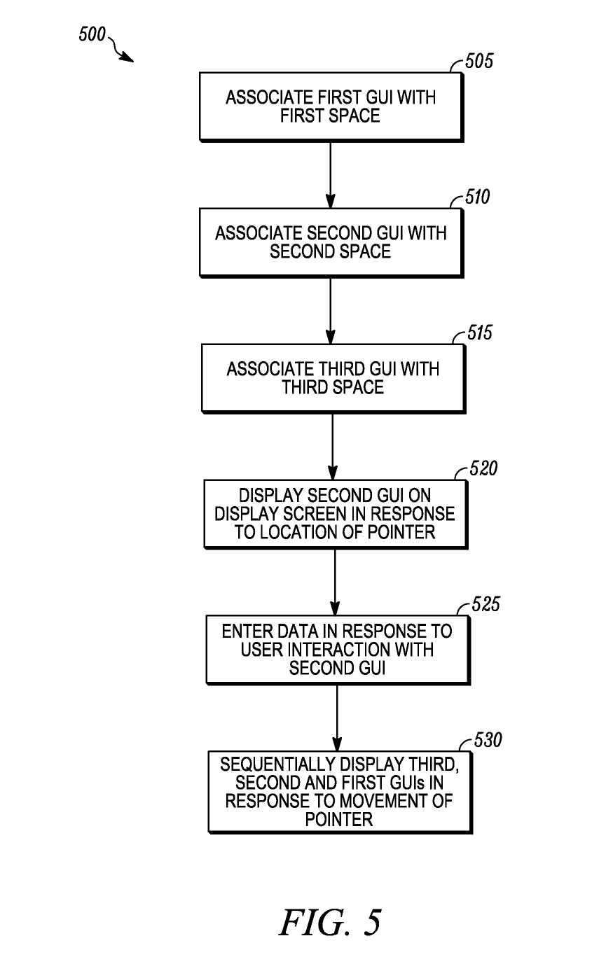

Referring to FIG. 5, a general flow diagram illustrates a method 500 for entering data into an electronic device, according to some embodiments of the present invention. At step 505 a first graphical user interface is associated with a first space defined between a control surface and a first plane substantially parallel to the control surface. For example, the first GUI 405 displaying control details of a media player is associated in the mobile telephone 100 with the first space 210, which is defined between an outer surface of the display screen 105 and the first plane 215. Those skilled in the art will appreciate that a control surface can be any of various types of surfaces such as a surface of a display screen, control tablet, or other surface with which a pointer can interact.

At step 510, a second graphical user interface is associated with a second space defined between the first plane and a second plane substantially parallel to the control surface. For example, the second GUI 410 displaying a playlist of a media player is associated in the mobile telephone 100 with the second space 220, which is defined between the first plane 215 and the second plane 225.

At step 515, a third graphical user interface is associated with a third space defined between the second plane and a third plane substantially parallel to the control surface. For example, the third GUI 415 displaying special effects of a media player is associated in the mobile telephone 100 with the third space 230, which is defined between the second plane 225 and the third plane 235.

At step 520, the second graphical user interface is displayed on a display screen of the electronic device in response to detecting a location of a pointer within the second space. For example, the second GUI 410 is displayed on the display screen 105 of the mobile telephone 100 in response to detecting a location of the tip 245 of the stylus 205 within the second space 220 and directly above the application layer selection region.

At step 525, data are entered into the electronic device in response to a user interaction with the second graphical user interface. For example, a user of the mobile telephone 100 may select a song from the playlist of the second GUI 410 by tapping the stylus 205 against the display screen 105.

At step 530, the display screen displays sequentially the third graphical user interface, then the second graphical user interface, and then the first graphical user interface in response to the pointer moving toward the control surface through, respectively, the third space, then through the second space, and then through the first space. For example, the display screen 105 displays sequentially the third GUI 415, then the second GUI 410, and then the first GUI 405 in response to the tip 245 of the stylus 205 moving directly above the local layer selection region 315 toward the display screen 105 through, respectively, the third space 230, then through the second space 220, and then through the first space 210.

Embodiments of the present invention therefore enable a user to enter data into an electronic device such as, for example, a mobile telephone, personal digital assistant, or digital camera, using intuitive and efficient three dimensional movements of a pointer. By dividing a volume above a control surface into various layers of three dimensional space, and associating each three dimensional space with a graphical user interface (GUI), GUIs that are intuitively perceived as stacked on top of each other, such as menus and sub-menus, pages of documents, or various magnifications of images, can be efficiently selected and manipulated by a user.

It will be appreciated that embodiments of the invention described herein may be comprised of one or more conventional processors and unique stored program instructions that control the one or more processors to implement, in conjunction with certain non-processor circuits, some, most, or all of the functions of entering data into an electronic device as described herein. The non-processor circuits may include, but are not limited to, a radio receiver, a radio transmitter, signal drivers, clock circuits, power source circuits, and user input devices. As such, these functions may be interpreted as steps of a method for entering data into an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for entering data into an electronic device, the method comprising:
associating a first graphical user interface with a first space defined between a control surface and a first plane substantially parallel to the control surface;
associating a second graphical user interface with a second space defined between the first plane and a second plane substantially parallel to the control surface;
displaying the second graphical user interface on a display screen of the electronic device in response to detecting a location of a pointer within the second space; and
entering data into the electronic device in response to a user interaction with the second graphical user interface.

2. The method of claim 1, further comprising associating a third graphical user interface with a third space defined between the second plane and a third plane substantially parallel to the control surface.

3. The method of claim 2, further comprising sequentially displaying on the display screen the third graphical user interface, then the second graphical user interface, and then the first graphical user interface in response to the pointer moving toward the control surface through, respectively, the third space, then through the second space, and then through the first space.

4. The method of claim 1, wherein the control surface is a surface of the display screen.

5. The method of claim 1, wherein the control surface is a portion of a surface of the display screen.

6. The method of claim 5, wherein another control surface that is another portion of the surface of the display screen is associated with a plurality of additional graphical user interfaces associated with the first graphical user interface or the second graphical user interface.

7. The method of claim 6, wherein the plurality of additional graphical user interfaces comprise sub-menus associated with the first graphical user interface or the second graphical user interface.

8. The method of claim 1, wherein the display screen displays a series of images that zoom in on an initial image in response to movement of the pointer toward the control surface, and the display screen displays a series of images that zoom out from an initial image in response to movement of the pointer away from the control surface.

9. The method of claim 1, wherein the location of the pointer is detected using three dimensional stereo imaging.

10. An electronic device comprising:
computer readable program code components configured to cause associating a first graphical user interface with a first space defined between a control surface and a first plane substantially parallel to the control surface;
computer readable program code components configured to cause associating a second graphical user interface with a second space defined between the first plane and a second plane substantially parallel to the control surface;
computer readable program code components configured to cause displaying the second graphical user interface on a display screen of the electronic device in response to detecting a location of a pointer within the second space; and
computer readable program code components configured to cause entering data into the electronic device in response to a user interaction with the second graphical user interface.

11. The device of claim 10, further comprising computer readable program code components configured to cause associating a third graphical user interface with a third space defined between the second plane and a third plane substantially parallel to the control surface.

12. The device of claim 11, further comprising computer readable program code components configured to cause sequentially displaying on the display screen the third graphical user interface, then the second graphical user interface, and then the first graphical user interface in response to the pointer moving toward the control surface through, respectively, the third space, then through the second space, and then through the first space.

13. The device of claim 10, wherein the control surface is a surface of the display screen.

14. The device of claim 10, wherein the control surface is a portion of a surface of the display screen.

15. The device of claim 14, wherein another control surface that is another portion of the surface of the display screen is associated with a plurality of additional graphical user interfaces associated with the first graphical user interface or the second graphical user interface.

16. The device of claim 15, wherein the plurality of additional graphical user interfaces comprise sub-menus associated with the first graphical user interface or the second graphical user interface.

17. The device of claim 10, wherein the display screen displays a series of images that zoom in on an initial image in response to movement of the pointer toward the control surface, and the display screen displays a series of images that zoom out from an initial image in response to movement of the pointer away from the control surface.

18. The device of claim 10, wherein the location of the pointer is detected using three dimensional stereo imaging.
